(19) United States
(12) Patent Application Publication
(10) Pub. No.: US 2017/0277869 A1
(43) Pub. Date: Sep. 28, 2017

(54) COMPUTING DEVICE AND DATA PROCESSING METHOD

(71) Applicant: MStar Semiconductor, Inc., Hsinchu Hsien (TW)

(72) Inventor: Chen-An Liu, Hsinchu Hsien (TW)

(21) Appl. No.: 15/368,917

(22) Filed: Dec. 5, 2016

(30) Foreign Application Priority Data
Mar. 25, 2016 (TW) 105109352

(51) Int. Cl. G06F 21/10; H04L 9/08; G06T 1/20; G06F 21/72

(52) U.S. Cl. CPC G06F 21/10; G06F 21/72; H04L 9/0822; G06T 1/20

(57) ABSTRACT

A data processing method applied to a rich execution environment (REE) and a trusted execution environment (TEE) is disclosed. The REE executes a client application (CA) and the TEE executes a trusted application (TA). The data processing method includes: allocating a storage space in a first storage space in the TEE in response to a request from the CA; sending address information indicating an address of the storage space to the CA; storing the address information in a second storage unit of the REE; obtaining the address information from the second storage unit and sending the address information and verification information to the TA; and generating a key according to the verification information, and storing the key to the storage space in the first storage unit according to the address information.

This application claims the benefit of Taiwan application Serial No. 105109352, filed Mar. 25, 2016, the subject matter of which is incorporated herein by reference.

### BACKGROUND OF THE INVENTION

### Field of the Invention

The invention relates in general to information security, and more particularly to a computing device and a data processing method capable of enhancing information security.

### Description of the Related Art

To achieve the object of information security, en execution environment of a computing device may be divided into a rich execution environment (REE) and a trusted execution environment (TEE). The REE has more abundant software resources but less satisfactory information security protection. On the other hand, the TEE has less software resources but higher information security protection.

A device that plays a protected multimedia file (e.g., an encrypted multimedia file) usually adopts the foregoing REE and TEE to prevent the protected multimedia file from theft. For example, a television that plays a protected multimedia file usually implements the REE and the TEE in its control chip, executes a client application (CA) in the REE, and correspondingly executes a trusted application (TA) in the TEE.

FIG. 1 shows a flowchart of an example of a conventional television playing a protected multimedia file. A multimedia player first transmits verification information to the television. After receiving the verification information transmitted from the multimedia file, the CA in the REE of the television sends the verification information to the TA of the TEE (step S110). The TA then computes a key according to the verification information (step S120). The key is later used to decrypt the protected multimedia file. The TA then encrypts the key (step S130), and sends an encrypted key to the CA (step S140). Next, the TA stores the encrypted key in a storage unit of the REE (step S150). After receiving an encrypted multimedia file (i.e., ciphertext), the TA obtains the encrypted key from the storage unit of the REE, and sends the encrypted multimedia file and the encrypted key to the TA (step S160). After receiving the encrypted multimedia file and the encrypted key, the TA first decrypts the encrypted key to generate the key (step S170), decrypts the encrypted multimedia file using the key to generate a decrypted multimedia file (i.e., cleartext) (step S180), and stores the decrypted multimedia file to a video buffer of the television (step S190) for playback.

The above process suffers from certain drawbacks. First of all, repeatedly transmitting the encrypted key occupies the system bandwidth. Secondly, storing the encrypted key in the storage unit of the REE increases the risks of cracking the key. Therefore, there is a need for a simpler and safer mechanism for overcoming the above drawbacks.

### SUMMARY OF THE INVENTION

The invention is directed to a computing device and a data processing method to enhance information security.

The present invention discloses a computing device having a rich execution environment (REE) and a trusted execution environment (REE). The REE and the TEE transmit data through a mailbox. The computing device includes: an REE circuit, implementing the REE, comprising a first processing unit executing a client application (CA) and a first storage unit coupled to the first processing unit; a TEE circuit, implementing the TEE, comprising a second processing unit executing a trusted application (TA) and a storage unit coupled to the second processing unit. The TA allocates a storage space in the second storage unit in response to a request from the TA, and sends address information indicating an address of the storage space to the CA. The CA stores the address information in the first storage unit, obtains the address information from the first storage unit, and sends the address information and verification information to the TA. The TA generates a key according to the verification information, and stores the key in the storage space according to the address information.

The present invention further discloses a data processing method applied to an REE and a TEE. The REE executes a CA and the TEE executes a TA. The REE and the TEE transmit data through a mailbox. The data processing method includes: allocating a storage space in a first storage unit of the TEE in response to a request from the CA by the TA; sending address information indicating an address of the storage space to the CA by the TA; storing the address information in a second storage unit in the REE by the CA; obtaining the address information from the second storage unit and sending the address information and verification information to the TA by the CA; and generating a key according to the verification information, and storing the key to the storage space of the first storage unit according to the address information by the TA.

The computing device and the data processing method of the present invention are capable of enhancing information security. As opposed to prior art, the computing device and the data processing method of the present invention prevent a key from being exposed in a risky environment and thus reduces the possibility of cracking the key.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a flowchart of a conventional television playing a protected multimedia file;

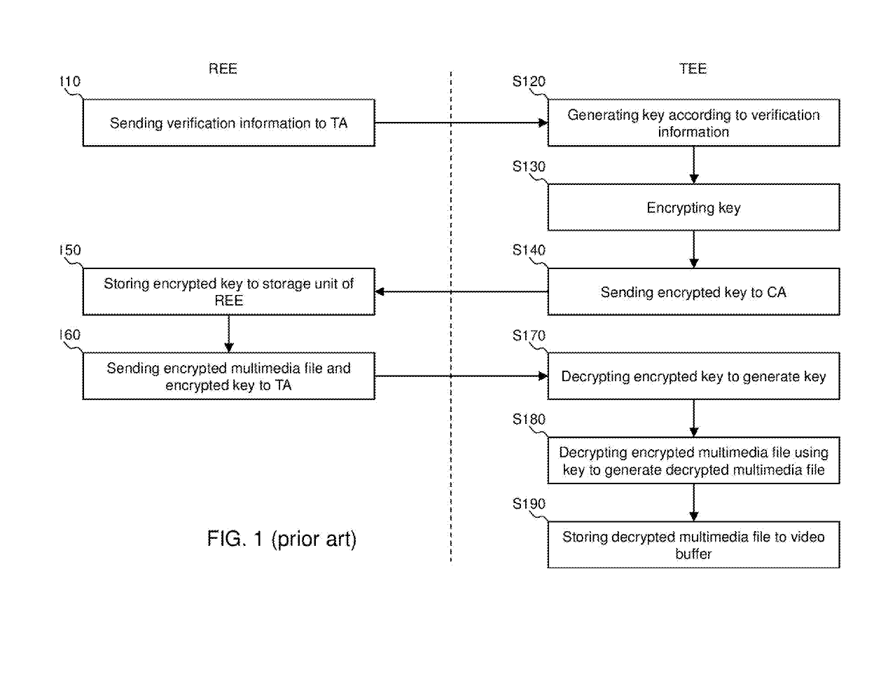

FIG. 2 is a function block diagram of a computing device according to an embodiment of the present invention; and

FIG. 3 is a flowchart of a data processing method according to an embodiment of the present invention.

### DETAILED DESCRIPTION OF THE INVENTION

The present invention discloses a computing device and a data processing method capable of enhancing information security. In possible implementation, one person skilled in the art can chose equivalent elements or steps to realize the present invention based on the disclosure of the application. That is, the implementation of the present invention is not limited to the non-limiting embodiments below.

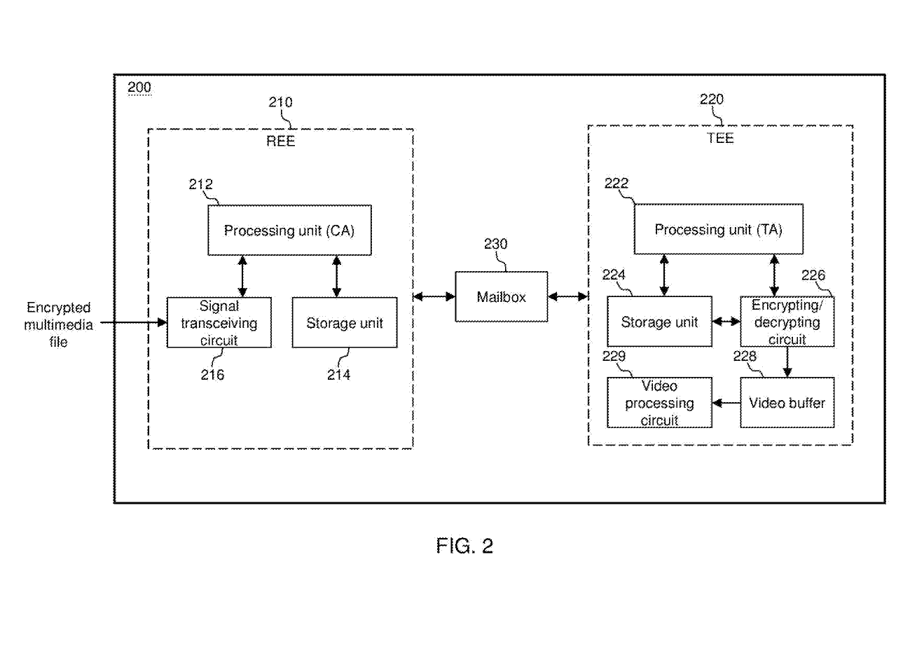

FIG. 2 shows a function block diagram of a computing device according to an embodiment of the present invention. A computing device 200 includes a rich execution environment (REE) 210 and a trusted execution environment (TEE) 220. The REE 210 and the TEE 220 transmit data through a mailbox 230. The REE 210 is implemented by an REE circuit, which includes, for example but not limited to, a processing unit 212, a storage unit 214 and a signal transceiving circuit 216. The processing unit 212 executes a client application (CA). Data and programs of the REE 210 are stored in the storage unit 214. The CA may receive and transmit data, e.g., an encrypted multimedia file (i.e., ciphertext), through the signal transceiving circuit 216. For example, the signal transceiving circuit 216 is a network signal transceiving circuit or a multimedia signal transceiving circuit, e.g., High Definition Multimedia Interface (HDMI). On the other hand, the TEE 220 is implemented by a TEE circuit, which includes, for example but not limited to, a processing unit 222, a storage unit 224, an encrypting/decrypting circuit 226, a video buffer 228 and a video processing circuit 229. The processing unit 222 executes a trusted application (TA). Data and programs of the TEE 220 are stored in the storage unit 224. The encrypting/decrypting circuit 226 is controlled by the TA, and performs data encryption and data decryption. The video buffer 228 stores a decrypted multimedia file (i.e., cleartext). The video processing circuit 229 reads the decrypted multimedia file from the video buffer 228, and performs video processing (e.g., decoding, decompression, de-interlacing and scaling) on the decrypted multimedia file for further playback.

The mailbox 230 may be implemented by a memory (e.g., DRAM). When one of the CA and the TA stores data into the mailbox 230, the other party is informed through setting a flag (e.g., changing a register value of the register). Similarly, the CA or the TA may learn whether the mailbox 230 contains data to be received. If so, the data in the mailbox 230 is moved to the respective storage unit 214 or 224, and the flag is then cleared. For example, the storage unit 214, the storage unit 224 and the mailbox 230 may be different memory blocks in the same physical memory. The memory block corresponding to the storage unit 224 of the TEE 220 is protected, i.e., the CA has no access to the memory block corresponding to the storage unit 224 in the memory. In FIG. 2, the TA and the CA are executed by different processing units 212 and 214; in other embodiments, the two may be executed by different cores of the same processing unit.

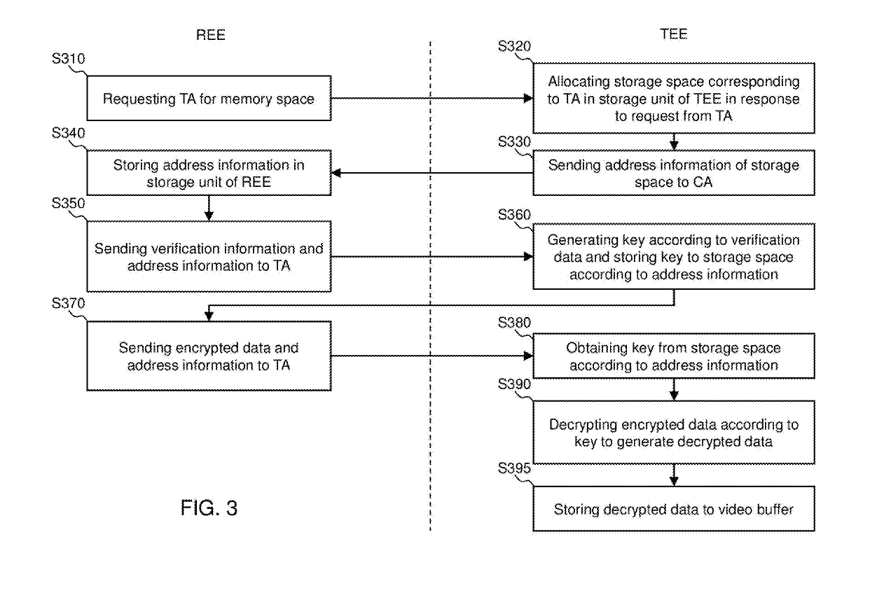

Operation details of the computing device 200 in FIG. 2 are illustrated with reference to a flowchart of a data processing method shown in FIG. 3 according to an embodiment of the present invention. The CA first requests the TA for a memory space (step S310). After receiving the request, the TA 222 allocates a storage space corresponding to the TA in the storage unit 224 of the TEE (step S320). The storage space is for later storing a key, and may be in a size of 1 KB to 8 KB, e.g., 4 KB.

After the allocation, the TA sends the address information of the storage space to the CA (step S330). The address information may be a physical address or a virtual address in the storage unit 224, or a pointer, a variable, a flag or an index corresponding to the memory address of the storage space in the storage unit 224. When the address information is a variable, a flag or an index, the storage unit 224 additionally stores a look-up table (LUT), which records the correspondence of the variable, the flag or the index and the memory address of the storage space. That is to say, the TA identifies the memory address of the memory space in the storage unit 224 from the LUT according to the variable, the flag or the index.

After receiving the address information, the CA stores the address information in the storage unit 214 of the REE (step S340).

Next, when the CA receives verification information, the CA sends the verification information and the address information to the TA (step S350).

The TA then generates a key according to the verification information, and stores the key in the storage space according to the address information (step S360). In one embodiment, the TA stores the key in form of cleartext. In another embodiment, the TA stores the key in form of ciphertext, i.e., the key is encrypted before it is stored to increase the security of the key.

When the CA later received encrypted data, the CA sends the encrypted data and the address information to the TA (step S370), and the TA obtains the key from the storage space according to the address information (step S380). If the key is in form of ciphertext, the TA needs to decrypt the key after obtaining the key.

After obtaining the key, the TA computes by software or controls the encrypting/decrypting circuit 226 to decrypt the data according to the key to generate decrypted data (step S390). When the above computing device 200 is applied to a television system, the computing device 200 may be a part of a control chip or a video processing chip of the television system, and the encrypted data and the decrypted data may be an encrypted multimedia file and a decrypted multimedia file, respectively. The decrypted multimedia file may be stored to the video buffer 228 by the TA or the encrypting/decrypting circuit 226 (step S395), and the video processing circuit 229 may then perform video processing such as decoding on the multimedia file before the multimedia file is played.

In one embodiment, the storage unit 224 and the video buffer 228 in the TEE may be different blocks of the same physical memory. Thus, when the encrypting/decrypting circuit 226 performs decryption, the encrypted data is read from a first block (i.e., the storage unit 224) of the physical memory and then decrypted. The decrypted data is stored to a second block (i.e., the video buffer 228) of the physical memory.

When the decryption process for the encrypted data is completed by the TA 222 through software computation, the encrypting/decrypting circuit 226 may be omitted, and the decrypted data obtained from decryption performed by the TA is directly stored to the video buffer 228.

The data amount of the key is usually 4 KB, and the data amount of the address information is usually 1 byte to 8 bytes (the data amount of a physical address, virtual address or pointer is usually 4 bytes or 8 bytes, and the data amount of a variable, flag or index is usually 1 byte). Thus, in the present invention, instead of sending the key itself, only address information of the key in the TEE in sent to the CA by the TA, so that the amount of data transmission amount can be significantly reduced to lower the system bandwidth usage. Further, because circuits or components outside the TEE have no access to the storage unit of the TEE, so the key is free from any theft even if the address information is cracked, hence considerably enhancing the security of the key. In conclusion, as opposed to prior art, the present invention significantly enhances the security of the key while reducing the system bandwidth usage.

One person skilled in the art can understand implementation details and variations of the method shown in FIG. 3 of the present invention with reference to the disclosure associated with the device in FIG. 2. While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A computing device, having a rich execution environment (REE) and a trusted execution environment (TEE), the REE and the TEE transmitting data through a mailbox, the computing device comprising:
an REE circuit, implementing the REE, comprising:
a first processing unit, executing a client application (CA); and
a first storage unit, coupled to the first processing unit; and
a TEE circuit, implementing the TEE, comprising:
a second processing unit, executing a trusted application (TA); and
a second storage unit, coupled to the second processing unit;
wherein, the TA allocates a storage space in the second storage unit in response to a request from the CA, and sends address information indicating an address of the storage space to the CA; the CA stores the address information in the first storage unit, the CA obtains the address information from the first storage unit, and sends the address information and verification information to the TA; and the TA generates a key according to the verification information, and stores the key to the storage space according to the address information.

2. The computing device according to claim 1, wherein the TEE circuit further comprises:
an encrypting/decrypting circuit, coupled to the second processing unit and the second storage unit;
the CA further sends encrypted data and the address information to the TA through the mailbox, and the TA obtains the key from the storage space according to the address information and controls the encrypting/decrypting circuit to decrypt the encrypted data according to the key.

3. The computing device according to claim 2, wherein the address information is a variable, a flag or an index corresponding to a memory address of the storage space in the second storage unit, the second storage space stores a look-up table (LUT), the LUT records correspondence of the variable, the flag or the index and the memory address of the storage space, and the TA identifies the memory address of the storage space in the second storage unit according to the address information and the LUT to obtain the key.

4. The computing device according to claim 2, wherein the address information is a memory address or a pointer of the storage space in the second storage unit.

5. The computing device according to claim 2, applied to a television system, wherein the TEE circuit further comprises:
a video processing circuit; and
a video buffer, coupled to the encrypting/decrypting circuit and the video processing circuit; and
the encrypting/decrypting circuit decrypts the encrypted data to obtain a multimedia file and stores the multimedia file to the video buffer, and the video processing circuit reads the multimedia file from the video buffer and decodes the multimedia file.

6. The computing device according to claim 1, wherein the TA further encrypts the key before storing the key to the storage space.

7. A data processing method, applied to a rich execution environment (REE) and a trusted execution environment (TEE), a client application (CA) being executed in the REE, a trusted application (TA) being executed in the REE, the REE and the TEE transmitting data through a mailbox, the data processing method comprising:
allocating a storage space in a first storage unit in the TEE in response to a request from the CA by the TA;
sending address information indicating an address of the storage space to the CA by the TA;
storing the address information to a second storage unit in the REE by the CA;
obtaining the address information from the second storage unit, and sending the address information and verification data to the TA by the CA; and
generating a key according to the verification information, and storing the key to the storage space in the first storage unit according to the address information by the TA.

8. The data processing method according to claim 7, further comprising:
further sending encrypted data and the address information to the TA through the mailbox by the CA;
obtaining the key from the storage space according to the address information by the TA; and
decrypting the encrypted data according to the key by the TA.

9. The data processing method according to claim 8, wherein the address information is a variable, a flag or an index corresponding to a memory address of the storage space in the first storage unit, the second storage space stores a look-up table (LUT), the LUT records correspondence of the variable, the flag or the index and the memory address of the storage space, the TA identifies the memory address of the storage space in the first storage unit according to the address information and the LUT to obtain the key.

10. The data processing method according to claim 8, wherein the address information is a memory address or a pointer of the storage space in the first storage unit.

11. The data processing method according to claim 8, applied to a television system, the television system comprising a video processing circuit, the TEE further comprising a video buffer for access by the video processing circuit, wherein a multimedia file is obtained after decrypting the encrypted data by the key, the data processing method further comprising:
storing the multimedia to the video buffer for the video processing circuit to decode.

12. The data processing method according to claim 7, further comprising:
encrypting the key before storing the key to the storage space by the TA.
